(19) United States
(12) Patent Application Publication
(10) Pub. No.: US 2026/0119957 A1
(43) Pub. Date: Apr. 30, 2026

(54) DECODING QUANTUM ERROR CORRECTION CODES USING TRANSFORMER NEURAL NETWORKS

(71) Applicant: Ramot at Tel-Aviv University Ltd., Tel-Aviv (IL)

(72) Inventors: Yoni CHOUKROUN, Tel Aviv (IL); Lior WOLF, Tel Aviv (IL)

(73) Assignee: Ramot at Tel-Aviv University Ltd., Tel-Aviv (IL)

(21) Appl. No.: 19/150,211

(22) PCT Filed: Jan. 16, 2024
(86) PCT No.: PCT/IL2024/050066

§ 371 Date: Jul. 23, 2025

Related U.S. Application Data
(60) Provisional application No. 63/440,625, filed on Jan. 23, 2023.

(51) Int. Cl. G06N 10/70; G06N 10/60

(52) U.S. Cl. CPC G06N 10/70; G06N 10/60

(57) ABSTRACT

Transformer neural network based decoder for decoding Quantum Error Correction Codes (QECC), comprising, an input layer, a plurality of decoding layers, and an output layer. The input layer is adapted to receive initial noise estimation computed by a noise estimator for noise injected to syndrome bits of codewords encoded using QECC and transmitted over transmission channel(s) subject to interference, and create embeddings for the syndrome bits. The decoding layers adapted to compute an estimated logical operator matrix of each codeword, each comprises a self-attention layer constructed according to a mask indicative of a relation between the embeddings derived from a parity-check matrix of the error correction code. The plurality of decoding layers are trained using a combined loss function directed to minimize LER, BER, and error rate of the noise estimator. The output layer is adapted to produce a vector representing predicted soft error of the codeword's logical operator matrix.

### RELATED APPLICATION/S

This application claims the benefit of priority of U.S. Provisional Patent Application No. 63/440,625 filed on Jan. 23, 2023, the contents of which are incorporated herein by reference in their entirety.

### BACKGROUND

The present invention, in some embodiments thereof, relates to training and using neural networks to decode quantum error correction codewords transmitted over transmission channels subject to interference, and, more specifically, training and using transformer neural network based decoders to quantum decode error correction codewords transmitted over transmission channels subject to interference.

Transmission of data over transmission channels, either wired and/or wireless is an essential building block for most modern era data technology applications, for example, computing platforms interconnections (e.g. wafer fabric, switched fabric, etc.), memory interfaces, communication channels, network links, and/or the like. Such transmission channels are often if not always subject to interferences such as, for example, noise, crosstalk, attenuation, etc. which may degrade the transmission channel and lead to loss of data at the receiving side.

In order to overcome such line degradation induced data loss, error correction information may be added to allow the receiving side to detect and correct errors in the received encoded data. Such methods may utilize one or more Error Correction Codes (ECC) and/or models as known in the art.

Quantum computing is constantly evolving and gaining traction in the industry as it may significantly boost computing performance. However, due to its inherent mechanics, quantum computing and data transfer may present new challenges not previously experienced in legacy information technology including the need to support robust data transfer over noisy channels.

In order to overcome this challenge, Quantum Error Correction Codes (QECC) may be used in which error correction data may be added which, similarly to ECC, may be used to detect and correct errors induced in the transmitted data by noise injected in the transmission channel.

### SUMMARY

It is an object of the present invention to provide, methods, systems and software program products for decoding quantum error codes using neural networks, specifically transformer neural networks. The foregoing and other objects are achieved by the features of the independent claims. Further implementation forms are apparent from the dependent claims, the description and the figures.

According to a first aspect of the present invention there is provided a transformer neural network based decoder for decoding quantum error correction codes, comprising an input layer, a plurality of decoding layers, and an output layer. The input layer is adapted to receive initial noise estimation computed by a noise estimator for noise injected to syndrome bits of one or more codewords encoded using a quantum error correction code and transmitted over a transmission channel subject to interference, and create embeddings for the syndrome bits. The plurality of decoding layers are adapted to compute an estimated logical operator matrix of each codeword. Each of the plurality of decoding layers comprises a self-attention layer comprising one or more head constructed according to a mask indicative of a relation between the embeddings, the relation between the embeddings is derived from a parity-check matrix of the error correction code such that the mask is adapted to unmask pairs of connected parity bits and mask pairs of unconnected parity bits. The plurality of decoding layers are trained using a combined loss function directed to minimize a logical error rate (LER), a bit error rate (BER), and an error rate of the noise estimator. The output layer adapted to produce a vector representing a predicted soft error of the logical operator matrix of the respective codeword.

According to a second aspect of the present invention there is provided a method of training a transformer neural network based decoder for decoding quantum error correction codes, comprising using one or more processors for:
Obtaining a plurality of training samples comprising a plurality of initial noise estimations computed by one or more noise estimators for noise injected to syndrome bits of one or more codeword encoded using one or more quantum error correction codes and transmitted over one or more transmission channels subject to interference.
Using the plurality of training samples to train a transformer neural network based decoder to decode codewords encoded using the one or more quantum error correction codes by computing an estimated logical operator matrix of a respective codeword by minimizing a combined loss function directed to minimize a Logical Error Rate (LER), a Bit Error Rate (BER), and an error rate of the noise estimator, and producing a vector representing a predicted soft error of the logical operator matrix of the codeword.
Outputting the trained transformer neural network based decoder for decoding one or more codewords encoded using one or more quantum error correction codes.

According to a third aspect of the present invention there is provided a method of using a transformer neural network based decoder for decoding quantum error correction codes, comprising:
Receiving initial noise estimation computed by a noise estimator for noise injected to syndrome bits of one or more codeword encoded using a quantum error correction code and transmitted over a transmission channel subject to interference.
Applying a trained neural network based decoder to compute an estimated logical operator matrix of the one or more codeword and produce a vector representing a predicted soft error of the logical operator matrix. The trained neural network based decoder is constructed of an input layer adapted to receive the initial noise estimation and create embeddings for the syndrome bits, a plurality of decoding layers adapted to compute an estimated logical operator matrix of the one or more codeword according to a mask indicative of a relation between the embeddings, and an output layer adapted to produce the vector representing the predicted soft error.
Outputting the vector representing the predicted soft error.

In a further implementation form of the first, second and/or third aspects, the mask is created based on an extended bipartite graph representation of the parity check matrix of the error correction code. The bipartite graph representation comprises a plurality of nodes connected via a plurality of edges. Each pair of connected bits comprises bits which share one or more nodes of the plurality of nodes and each pair of unconnected bits comprises bits which do not share any node of the plurality of nodes.

In a further implementation form of the first, second and/or third aspects, the bipartite graph is a Tanner graph.

In a further implementation form of the first, second and/or third aspects, each of the plurality of decoding layers further comprises a feed forward layer interleaved by a normalization layer from the self-attention layer.

In a further implementation form of the first, second and/or third aspects, the embeddings created by the input layer have a higher dimension than the dimension of the received initial noise estimation.

In a further implementation form of the first, second and/or third aspects, the output layer is configured to reduce a dimension of the soft error vector concatenating a plurality of soft error vectors computed by the plurality of decoding layers based on the embeddings.

In a further implementation form of the first, second and/or third aspects, each of the combined loss function is adjusted according to a respective weight assigned to each of the LER, the BER, and the error rate of the noise estimator.

In a further implementation form of the first, second and/or third aspects, the parity-check matrix comprises a bit-flip parity check matrix computed for correcting qubits bit-flips and a phase-flip parity check matrix computed for correcting qubits phase-flips.

In a further implementation form of the first, second and/or third aspects, the noise estimator is implemented using one or more shallow neural networks parametrized during training using a plurality of training samples comprising a plurality of sets of syndrome bits injected with a noise.

In a further implementation form of the first, second and/or third aspects, the quantum error correction code is a member of a group comprising: a stabilizer code, a surface code, and a topological code.

In a further implementation form of the first, second and/or third aspects, a loss function of the LER is defined based on a binary cross entropy loss across the predicted soft error computed by the trained transformer neural network based decoder.

In an optional implementation form of the first, second and/or third aspects, the loss function of the LER is redefined as a differentiable loss function using a differentiable equivalence mapping of XOR operation over a binary module two thus enabling minimization of the differentiable loss function of the LER.

In an optional implementation form of the first, second and/or third aspects, the differentiable loss function of the LER is redefined based on binarization of the predicted soft error.

In an optional implementation form of the first, second and/or third aspects, the differentiable loss function of the LER is regularized.

In a further implementation form of the first, second and/or third aspects, the one or more noise estimators comprise one or more shallow neural networks trained to compute the initial noise estimations using a plurality of training samples comprising syndrome bits of the one or more codeword encoded using the one or more quantum error correction code by minimizing a binary cross entropy loss across the syndrome bits.

In a further implementation form of the first, second and/or third aspects, the one or more encoded codewords used for creating the training samples comprise the zero codeword.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced. In the drawings:

FIG. 1 is a schematic illustration of an exemplary transmission system comprising a neural network based decoder trained to decode quantum error correction codes transmitted over a transmission channel, according to some embodiments of the present invention;

FIG. 2 is a schematic illustration of an exemplary transformer neural network based decoder trained to decode error correction code transmitted over a transmission channel;

FIG. 3 is a schematic illustration of an exemplary transformer neural network based decoder trained to decode quantum error correction code transmitted over a transmission channel, according to some embodiments of the present invention;

FIG. 4A and FIG. 4B present schematic illustrations of exemplary masks computed for a transformer neural network based decoder based on a graphical representation of respective error correction codes, according to some embodiments of the present invention;

FIG. 5 is a flowchart of an exemplary process of training a transformer neural network based decoder to decode quantum error correction codes, according to some embodiments of the present invention;

FIG. 6 is a flowchart of an exemplary process of using a trained transformer neural network based decoder to decode quantum error correction codes, according to some embodiments of the present invention;

FIG. 7 is a schematic illustration of an lattice representation of an exemplary Toric code used by a transformer neural network based decoder, according to some embodiments of the present invention;

FIG. 8A, FIG. 8B, FIG. 8C, FIG. 8D, FIG. 8E and FIG. 8F are graph charts comparing decoding performance for several legacy decoders and transformer neural network based decoders applied to decode quantum error correction codes, according to some embodiments of the present invention; and

FIG. 9A, FIG. 9B and FIG. 9C are graph charts demonstrating impact of design parameters on decoding performance of transformer neural network based decoders applied to decode quantum error correction codes, according to some embodiments of the present invention.

### DETAILED DESCRIPTION

The present invention, in some embodiments thereof, relates to training and using neural networks to decode quantum error correction codewords transmitted over transmission channels subject to interference, and, more specifically, training and using transformer neural network based decoders to quantum decode error correction codewords transmitted over transmission channels subject to interference.

Wired and/or wireless transmission channels are basic building blocks for data transmission applications such as, for example, communication channels, network links, memory interfaces, components interconnections (e.g. bus, switched fabric, etc.) and/or the like. However, data transmitted via such transmission channels which are subject to one or more interferences such as, for example, noise, crosstalk, attenuation, and/or the like may often suffer errors induced by the interference.

Error correction codes may be therefore applied in the physical communication layer for encoding codewords transmitted via transmission channels to enable receiving decoders to efficiently detection and possibly correct errors in the transmitted encoded codewords in order to increase efficiency of the decoders to correctly recover the codewords while maintaining high transmission rates.

Quantum computing may experience similar transmission channel interferences and may present further challenges which do not exist in the classical (non-quantum) computing and communication domain. First, the no-cloning theorem for quantum states prevents cloning a quantum state and thus prevents adding arbitrarily redundant parity information, as done in classical ECC. Moreover, data in the quantum domain may suffer also phase-flips in addition to bit-flips while classical ECC addresses only bit-flip errors. Also, while bits measurements is standard in classical ECC, the wave function collapse phenomenon prevents direct measurements of the quantum data qubits since such measurement causes the wave function to collapse and erase the encoded quantum information.

These challenges may prevent trivial application of the existing ECC technology in the quantum computing domain.

According to some embodiments of the present invention, there are provided methods and systems for constructing a novel neural network based decoder architecture for decoding Quantum Error Correction Codes (QECC) transmitted via transmission channels subject to interference.

In particular, the neural network based decoder architecture may rely on model-free networks which are specifically adapted (customized, conditioned) for the error correction codes, for example, transformer neural networks having self-attention decoding layers specifically adapted for the quantum error correction codes used to encode the codewords, for example, stabilizer codes, topological codes, surface codes, and/or the like.

The transformer neural network based QECC decoders, interchangeably designated QECCT herein after, takes advantage of the state of the art transformer neural network based ECC decoders (ECCT) technology, with some modification adapting it for efficient and high performance QECC decoding.

As such, similarly to the ECCT decoder, the QECCT decoder may comprise an input layer adapted to create embeddings for received encoded codewords, a plurality of self-attention decoding layers adapted and trained for decoding and an output layer adapted to reduce dimensionality of the concatenated decoded output coming out of the decoding layer and recover the encoded codeword.

However, as opposed to the ECCT decoder, since the magnitude of the codeword qubits cannot be measured, the QECCT decoder, specifically its input layer, is adapted to create high-dimension embeddings for initial noise estimations computed for the syndrome bits of the codeword which are measurable.

The initial noise estimations may be computed for the syndrome bits using one or more noise estimators, optionally implemented using one or more trained neural networks, typically shallow neural networks. Due to potential measurement error, the syndrome bits may be sampled repetitively in order to overcome the measurement error limitation.

In addition, rather than recovering the encoded codeword as done by the ECCT decoder, the decoding layers of the QECCT decoder are adapted to recover the logical operator mapping of the encoded codeword which commutes with the encoded codeword. In particular, the QECCT decoder's decoding layers may recover the logical operator's matrix based on the embeddings, created for the syndrome bits, according to a mask derived from the parity check matrix which is indicative of the relation between each pair of syndrome bits. As such, the QECCT decoder may be conditioned to decode the codewords' logical operator mapping based on bits of the syndrome which are connected while ignoring unconnected syndrome which are masked by the mask.

During training of the QECCT decoder, the decoding layers are trained to optimize a combined loss function (objective) combining the loss over the logical operator, designated Logical Error Rate (LER), the loss over the data, known as Bit Error Rate (BER), and the loss over the noise estimator applied to compute the initial noise estimations.

Since the LER loss function (objective) may be highly non-differentiable and thus difficult to optimize, the LER loss function may be redefined as a differentiable equivalence of the non-differentiable LER loss function. The differentiable LER loss function may be manipulated to apply binary quantization and regularization.

The QECCT decoder may present significant advantages and benefits compared to existing quantum error correction code decoders including such decoders which employ neural network decoding.

First, adapting the QECCT decoders to decode the logical operator mapping of codewords encoded using QECC may overcome the inherent limitation of the quantum computing domain, which are described herein before, i.e., no-cloning, bit-flips and phase-flips, and the wave function collapse.

Moreover, due to a sparse design of the quantum error correction codes for which the QECCT decoder is conditioned, training and deployment of the QECCT decoders may be highly more simple and affordable in terms of computing resources and/or time compared to the existing neural network decoders, both model-free and model based.

Furthermore, conditioning the QECCT decoders by masking unconnected syndrome bits and relying only on connected bits may significantly improve decoding performance of the QECCT decoder, for example, accuracy, reliability, consistency, robustness, and/or the like while significantly reducing decoding computing resources, for example, processing resources, storage resources, computing time, and/or the like.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

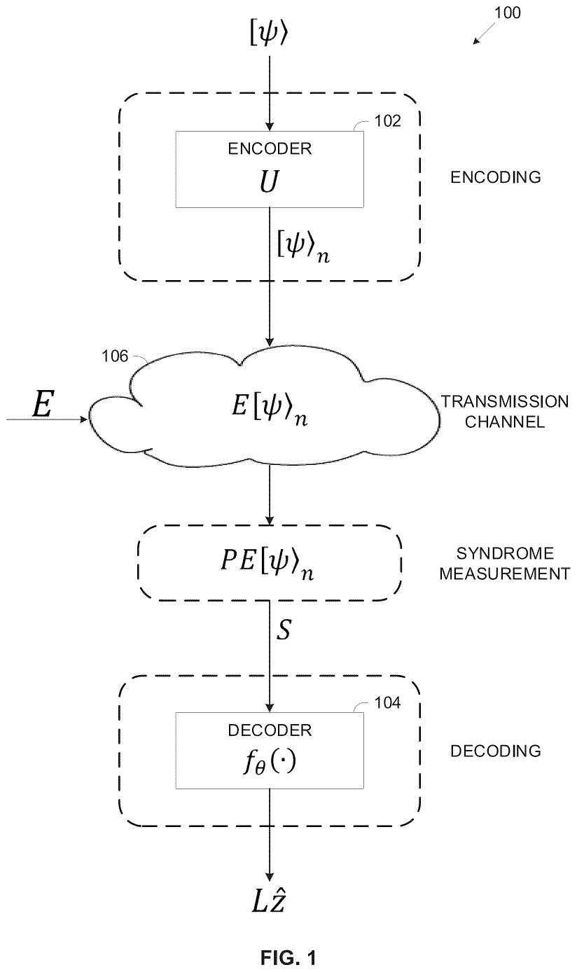

Referring now to the drawings, FIG. 1 is a schematic illustration of an exemplary transmission system comprising a neural network based decoder trained to decode quantum error correction codes transmitted over a transmission channel, according to some embodiments of the present invention.

An exemplary transmission system 100 may include an encoder 102 adapted to encode data (messages), specifically quantum data transmitted via a transmission channel 106 which may be decoded by a decoder 104 adapted to decode the encoded data and recover it.

The encoder 102 and decoder 104 may be part of a transmitter and receiver respectively (not shown) which may further include one or more additional circuits, modules and/or functions. For example, in case of communication systems, the transmitter may include a modulator configured to modulate the quantum data encoded by the encoder 102 according to one or more modulation schemes as known in the art.

The transmission channel 106 which may comprise one or more wired and/or wireless transmission channels may be directed to one or more of a plurality of applications, for example, communication channels, network links, memory interfaces, components interconnections (e.g. bus, switched fabric, etc.) and/or the like.

In particular, the transmission channel 106 may be subject to one or more interferences, for example, noise, crosstalk, attenuation, and/or the like which may induce one or more errors into the transited data.

Therefore, in order to overcome data corruption induced by interference(s) in quantum system, which are known for being highly noisy, the encoder 102 be configured to encode the transmitted quantum data according to one or more Quantum Error Correction Codes (QECC), models and/or protocols as known in the art to support error detection and/or correction, for example, a stabilizer code, a topological code, a surface code, and/or the like.

The decoder 104 may be a neural network based decoder 204 comprising one or more neural networks trained to decode QECC codes, typically Deep Learning (DL) neural networks, such as for example, a Fully Connected (FC) neural network, a Convolutional Neural Network (CNN), a Feed-Forward (FF) neural network, a Recurring Neural Network (RNN) and/or the like.

In particular, similarly to the ECCT, the decoder 104 may employ a model-free transformer architecture, meaning that the neural network based decoder 104 may not rely on any specific decoding model such as, for example, Belief Propagation (BP), and/or the like. The transformer neural network based QECC decoder 104 may be therefore interchangeably designated QECC Transformer (QECCT).

Adapting existing classical ECC methods to QECC is not straightforward due to inherent mechanics and principals of quantum computing which may present challenges not previously experienced in legacy information technology, specifically with respect to Error Correction Codes (ECC).

The first difficulty in applying ECC-based knowledge to QECC arises from the no-cloning theorem for quantum states which asserts that it is impossible to clone a quantum state and thus add arbitrarily redundant parity information, as done in classical ECC. The second challenge is the need to detect and correct quantum continuous bit-flips, as well as phase-flips while classical ECC addresses only bit-flip errors. A third major challenge is the wave function collapse phenomenon which prevents direct measurements, while being standard in ECC, of the qubits since it would cause the wave function to collapse and erase the encoded quantum information.

QECC schemes and methods were developed to overcome these challenges. For example, threshold theorems have shown that increasing the distance of a code will result in a corresponding reduction in the logical error rate, signifying that quantum error correction codes may arbitrarily suppress the logical error rate. This distance increase may be obtained by developing encoding schemes that reliably store and process information in a logical set of qubits, by encoding it redundantly on top of a larger set of less reliable physical qubits.

Most current QECC methods fall in the category of stabilizer codes, which may be seen as a generalization of the classical linear codes. Similarly to the classical parity check constraints, a group of stabilizer operators may provide a syndrome, while preserving the logical quantum states and enabling error detection.

Optimal decoding may be defined by the unfeasible NP-hard maximum likelihood rule. Considerable research dedicated to the design of codes with some additional algebraic structure has been done in order to support efficient decoding, for example, topological codes, in particular surface codes which originated from Toric codes.

Topological QECC codes may encode every logical qubit in a 2 Dimensional (2D) lattice of physical qubits. This local design of the code via nearest-neighbors coupled qubits allows the correction of a wide range of errors. Moreover, under certain assumptions, surface codes may provide an exponential reduction in the error rate.

The decoder 104 may employ one or more transformer neural network based decoders as known in the art for decoding ECC codes.

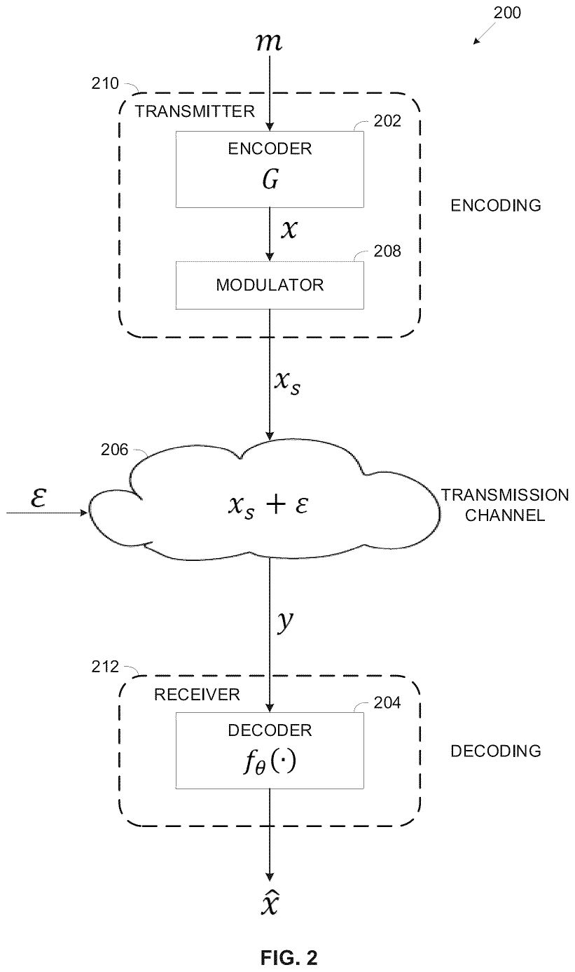

Reference is now made to FIG. 2, which is a schematic illustration of an exemplary transformer neural network based decoder trained to decode error correction code transmitted over a transmission channel.

An exemplary transmission system 200 may include a transmitter 210 which may transmit data (messages) to a receiver 212 via a transmission channel 206 such as the transmission channel 106 which may be subject to one or more interferences. The transmitter 102 may comprise an encoder 202 configured to encode the transmitted data according to one or more ECC codes, models and/or protocols as known in the art, for example, linear block codes such as, for example, algebraic linear code, polar code, LDPC, HDPC, and/or the like. However, the ECC codes may further include non-block codes such as, for example, convolutional codes and/or the like and also non-linear codes such as, for example, Hadamard code and/or the like.

The transmitter 210 illustrated in general terms only may further include one or more additional circuits, modules and/or functions, for example, a modulator 208 adapted to modulate the data encoded by the encoder 202 according to one or more modulation schemes as known in the art, for example, Binary Phase Shift Keying (BPSK), Quadrature Phase Shift Keying (QPSK), and/or the like.

The receiver 212 which is also illustrated in general terms only may comprise a decoder 204, in particular a neural network based decoder 204 comprising one or more trained neural networks as known in the art, for example, a DL neural network, a transformer neural network, an FC neural network, a CNN, a FF neural network, an RNN, and/or the like. In particular, the decoder 204 may employ the model-free transformer architecture and may be therefore interchangeably designated ECC Transformer (ECCT).

A classical ECC linear code C may be defined by a binary generator matrix G of size k×n and a binary parity check matrix H of size (n−k)×n such that GH^{T}=0 over the two elements' Galois field GF(2), i.e., order 2 Galois field.

The encoder 202 applying the generator matrix G may therefore encode an input data messages m∈{0,1}^{k} into codewords x=G^{T}m∈{0,1}ⁿ of size k×n ( ) where codeword x∈C⊂{0,1}ⁿ satisfies Hx=0.

The modulator 208 may modulate the encoded codeword x according to one or more of the modulation schemes, for example, BPSK, i.e., over {±1} to produce xₛ denoting the modulation of x. The modulated encoded codeword xₛ may be transmitted via the transmission channel 206, for example, a symmetric (potentially binary) transmission channel, such as for example, e.g., an Additive White Gaussian Noise (AWGN) channel.

The output of the transmission channel 206 which is received by the receiver 212 may be denoted by y represented by y=xₛ+ε∈ [symbol] ⊆ [symbol] ⁿ and ε is a random interference (noise) independent of the transmitted codeword x.

The goal of the decoder 204 f: [symbol] =→{0,1}ⁿ is to compute, estimate, predict and/or otherwise provide an approximation of the codeword \hat{x}=f(y).

An important notion in ECC is the syndrome, which is obtained by multiplying the binary mapping of y with the parity check matrix H over GF(2) as described in equation 1 below:

$$s : = s ( y ) = {Hy}_{b} : = H ( x ⊗ {ε}_{b} ) = H {ε}_{b} \qquad Equation 1$$

Where ⊗ denotes the XOR operator, and y_{b} and ε_{b} denote the hard-decision vectors of y and ε, respectively.

When discussing Quantum Error Correction Code (QECC), the fundamental transition to the quantum realm is defined by the shift from the classical bit to the quantum bit (qubit), whose quantum state [ψ [symbol] is defined by equation 2 below.

$$[ ψ 〉 = α [ 0 〉 + β \vert 1 〉 , s . t . α , β ∈ ℂ , {\vert α \vert}^{2} + {\vert β \vert}^{2} = 1 \qquad Equation 2$$

A coherent quantum error process E may be decomposed into a sum of operators from the Pauli set {1, X, Z, X Z}, where the Pauli basis is defined by the identity mapping I, the quantum bit-flip X and the phase-flip Z as expressed by equation 3 below.

$$I [ ψ 〉 = [ ψ 〉 \qquad Equation 3$$

$$X [ ψ 〉 = α X [ 0 〉 + β X \vert 1 〉 = α [ 0 〉 + β \vert 1 〉$$

$$Z [ ψ 〉 = α Z [ 0 〉 + β Z \vert 1 〉 = α [ 0 〉 - β \vert 1 〉$$

Accordingly a single-qubit error may be defined by equation 4 below.

$$E [ ψ 〉 = {α}_{I} [ ψ 〉 + {α}_{X} X [ ψ 〉 + {α}_{Z} Z [ ψ 〉 + {α}_{X Z} X Z [ ψ 〉 \qquad Equation 4$$

Where α₁, α_{X}, α_{Z}, α_{XZ}∈ [symbol] are expansion coefficients of the noise process.

According to the no-cloning theorem, a quantum state [ψ [symbol] cannot be copied redundantly, i.e., [ψ [symbol] ⊗ . . . ⊗[ψ [symbol] where n{⊗ . . . ⊗} denotes an n-fold tensor product. However, quantum information redundancy may be possible through a logical state encoding [ψ [symbol] , of a given quantum state [ψ [symbol] via quantum entanglement and a unitary operator U such that [ψ [symbol] ₙ=U(ψ [symbol] ⊗[0 [symbol] ⊗ . . . [0 [symbol] ).

An example of such a unitary operator is the GHZ state (Greenberger, Horne, and Zeilinger), which is generated with CNOT gates. In [ψ [symbol] ₙ, the logical state is defined within a subspace of the expanded Hilbert space, which determines both the codespace [symbol] and its orthogonal error space F defined such that E[ψ [symbol] ₙ ∈ [symbol] .

The orthogonality of [symbol] and [symbol] makes it possible to determine the subspace occupied by the logical qubit through projective measurement, without compromising the encoded quantum information. In the context of quantum coding, the set [symbol] of non-destructive measurements of this type are called stabilizer measurements and may be performed via additional qubits, for example, ancilla bits.

The result of the stabilizer measurements on a given state is called the syndrome, such that for a given stabilizer generator P∈ [symbol] , P[ψ [symbol] ₙ=[ψ [symbol] ₙ and PE[ψ [symbol] ₙ=−E[ψ [symbol] , where ∀[ψ [symbol] ₙ ∈ [symbol] given an anti-commuting (i.e. −1 eigenvalue) and thus detectable error E. As known in the art, in case the syndrome measurement is faulty, it might be necessary to repeat it to improve confidence in the outcome.

An important class of Pauli operators is the class of logical operators. These operators are not elements of the stabilizer group but may commute with every stabilizer. While stabilizers operators may act trivially in the code space, i.e. P[ψ [symbol] ₙ=[ψ [symbol] ₙ, logical operators [symbol] ∈ [symbol] may act non-trivially in it, i.e. ∃[φ [symbol] ₙ∈ [symbol] s.t. [symbol] [ψ [symbol] ₙ=[ψ [symbol] ₙ.

Such operators may commute with the stabilizers but may also represent undetectable errors. Thus, similarly to the classical information bits, QECC benchmarks generally adopt logical error metrics, which measure the discrepancy between the predicted projected noise [symbol] \hat{ε} and the real one [symbol] ε, where [symbol] is the discrete logical operators' matrix.

Referring once again to FIG. 1.

When addressing QECC from the ECC perspective, another way to represent stabilizer codes is to split the stabilizer operators into two independent parity check matrices by defining the block parity check matrix as

$$H = ( \begin{matrix}{H}_{Z} & 0 \\ 0 & {H}_{X}\end{matrix} )$$

thus separating between phase-flip checks H_{Z} and bit-flip checks H_{X}. The syndrome s is then computed as s=Hε, where H is the check-matrix defined according to the code stabilizers in [symbol] , and ε the binary noise.

The main goal of the quantum decoder 104 f{0,1 [symbol] →{0,1 [symbol] is to provide a noise approximation given only the syndrome s.

Therefore, the quantum data decoding scheme may be reduced to its classical counterpart as follows. The k logical qubits are similar to the classical k information bits, and the n physical qubits are similar to the classical codeword. The syndrome of the quantum state may be computed or simulated similarly to the classical way, by defining the binary parity check matrix built upon the code quantum stabilizers.

There are however several differences in decoder 102 adapted for QECC decoding compared to classical ECC. First, there is no access to the current state, while arbitrary measurement of y is standard for classical ECC. In addition, the objective is the logical qubits, meaning the code may be predicted up to the logical operators mapping [symbol] . Finally, repetitive sampling of the syndrome may be applied due to the syndrome measurement error.

The goal of the decoder 104 is to learn a transformer neural network parameterized by weights θ such that \hat{ε}=f_{θ}(s).

The decoder 104 may built on ECC Transformer architecture as known in the art with several modifications.

The input to the transformer neural network QECC decoder (QECCT), designated h(y) may be defined by the concatenation of the codeword-independent magnitude and syndrome s, such that h(y):=[|y|, 1−2s(y)]∈ [symbol] ^{2n-k} where [·,·] denotes vector concatenation.

Each element may be then embedded into a high dimensional space for more expressivity, such that the initial positional embedding Φ may be expressed, for example, by

$$Φ = ( h ( y ) \cdot {1}_{d}^{T} ) ⊙ W ,$$

where W∈ [symbol] ^{(2n-k)×d} is the learnable embedding matrix and ⊙ is the Hadamard product.

The interaction between the bits is performed naturally via self-attention modules of the QECCT decoder 104 coupled with a binary mask derived from the parity-check matrix expressed in equation 5 below.

$${A}_{H} ( Q , K , V ) = Softmax ( {d}^{- 1 / 2} ( {QK}^{T} + g ( H ) ) ) V \qquad Equation 5$$

Where g(H) is a binary masking function designed according to the parity-check matrix H, and Q, K, V are the classical self-attention projection matrices.

Masking enables the incorporation of sparse and efficient information about the code while avoiding the loop vulnerability of belief propagation-based decoders.

Finally, the transformed embedding is projected onto a one-dimensional vector for noise prediction. The computational complexity is O(N(d²n+hd)), where N denotes the number of layers of the QECCT decoder 104, n is the code length, and h<<n² denotes the number of elements in the mask, which may be typically very small for sparse codes, including Toric codes, Surface codes, and/or the like.

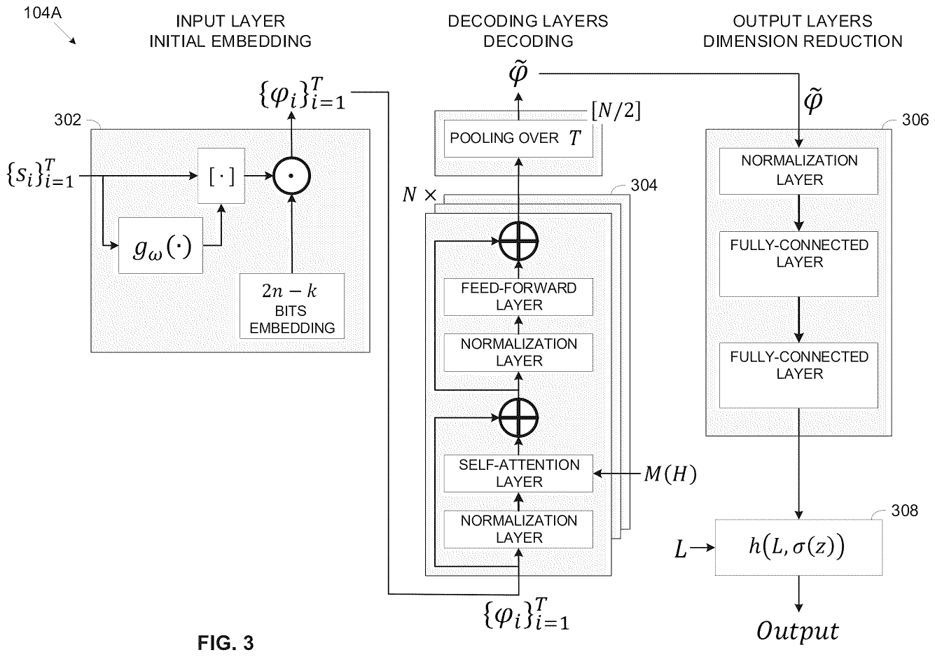

Reference is now made to FIG. 3, which is a schematic illustration of an exemplary transformer neural network based decoder trained to decode quantum error correction code transmitted over a transmission channel, according to some embodiments of the present invention.

An exemplary transformer neural network based decoder 104A such as the transformer neural network based decoder 104 (QECCT) adapted and trained for decoding one or more codewords encoded using QECC, for example, a stabilizer code, a Toric code, a topographic code, a surface code, and/or the like and transmitted over a transmission channel such as the transmission channel 106 subject to interference may be constructed of an input layer 302, a plurality (N) of decoding layers 304 and an output layer 306.

As before, the binary block parity check matrix of the QECC is denoted by H, the noise, for example, binary nose is denoted by ¿, the syndrome (bits) is denoted s=Hε, and the logical operators' binary matrix by [symbol] .

Moreover, as stated herein before, the parity-check matrix H may comprise a bit-flip parity check matrix computed for correcting qubits bit-flips and a phase-flip parity check matrix computed for correcting qubits phase-flips.

The input layer 302 may be adapted to receive initial noise estimation

$${\{ {s}_{i} \}}_{i = 1}^{T}$$

computed by a noise estimator g_{ω} for noise injected to the syndrome bits sᵢ of the syndrome s of the received encoded codeword and create embeddings for the syndrome bits according to the initial noise estimations.

While syndrome decoding is a well-known procedure in ECC, most popular decoders, and especially neural network based decoders, assume the availability of arbitrary measurements of the output of the transmission channel 106. In the QECC setting, however, only the syndrome s is available, since classical measurements are not allowed due to the wave function collapse phenomenon.

Therefore, in order to overcome the measurement collapse, the classical ECC transformer neural network based decoder (ECCT) may be extended to a QECC transformer neural network based decoder (QECCT) by replacing the magnitude of the channel output y with an initial estimate of the noise in the syndrome s to be further refined by the code-aware network. In other words, the channel's output magnitude measurement h(y)=[|y|, 1−2s] may be replaced by h_{q}(s)=[g_{ω}(s),s].

The noise estimator g_{ω}:{0,1}ⁿ^{ₛ}→ [symbol] ⁿ may be implemented using one or more shallow neural networks parametrized by w during training for estimating the initial noise estimation. During its training, the neural network based noise estimator g_{ω} may be fed with a plurality of training samples comprising a plurality of sets of syndrome bits of one or more codewords encoded using one or more QECC and injected with one or more noise patterns, for example, white nose, Gaussian white noise, and/or the like.

As a non-linear transformation of the syndrome s, the noise estimator g_{ω} may be independent of the quantum state/codeword and thus may be highly robust to overfitting. The noise estimator g_{ω} may be trained using a loss function (objective) expressed by equation 6 below.

$${ℒ}_{g} = BCE ( {g}_{ω} ( s ) , ε ) \qquad Equation 6$$

Where BCE is the binary cross entropy loss.

The shift from using the transmission channel's output magnitude to using the initial error estimation is crucial for overcoming quantum measurement collapse and, as discussed herein after may significantly improve decoding performance of the decoder 104A.

The embeddings created by the input layer 302 may obviously have a higher dimension than the dimension of the received initial noise estimation. For example, the for a code length n, the embeddings may be of dimension n+s.

Contrary to classical ECC, quantum error correction aims to restore the noise up to a logical generator of the code, such that several solutions can be valid error correction.

Denoting the ECCT by f_{θ}, the output \hat{z} of the decoder 104A may be therefore recovered according to equation 7 below.

$$\hat{z} = {f}_{θ} ( {h}_{q} ( s ) ) = {f}_{θ} ( [ {g}_{ω} ( s ) , s ] ) \qquad Equation 7$$

The decoding layers 304 may be therefore adapted to compute an estimated logical operator matrix of the received encoded codeword. Each of the plurality of decoding layers 304 may comprise a self-attention layer comprising one or more heads constructed according to a mask indicative of a relation between the embeddings. The mask indicative of the relation between the embeddings is derived from the parity-check matrix H of the quantum error correction code. As such, the mask may be adapted to unmask pairs of connected parity bits and mask pairs of unconnected parity bits.

In particular, the ECCT f_{θ} may process the estimated noise input and perform decoding by analyzing the input-syndrome interactions according to a mask obtained, derived, and/or computed according to the QECC used to encode the received codeword(s). The mask may be indicative of relations between the bits sᵢ of the syndrome s expressing which pairs of bits are highly related and which are not.

The mask may be created, for example, based on an extended bipartite graph representation of the parity check matrix H of the quantum error correction code, for example, a Tanner graph, a Factor graph, and/or the like which comprise a plurality of nodes connected via a plurality of edges. Each pair of connected bits comprises bits which share one or more nodes of the plurality of nodes and each pair of unconnected bits comprises bits which do not share any node of the plurality of nodes.

Using the mask, the self-attention mechanism of the decoder 104A, specifically of the decoding layers 304 may take into consideration bits related to each other in terms of the QECC, i.e., the parity-check matrix H, for example, the stabilizers. By using adapted masking obtained from the parity-check matrix H, the quantum transformer neural network based decoder 104A (QECCT) may be able to learn dependencies between related qubits. However, it is important to note that analogous expansions may be straightforward to apply to other neural decoder architectures and not only transformer neural networks.

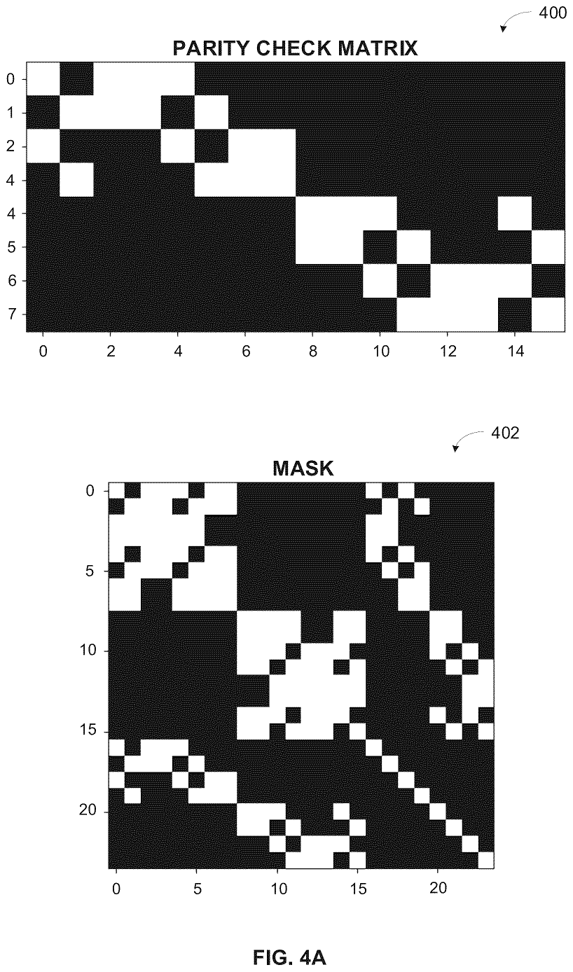

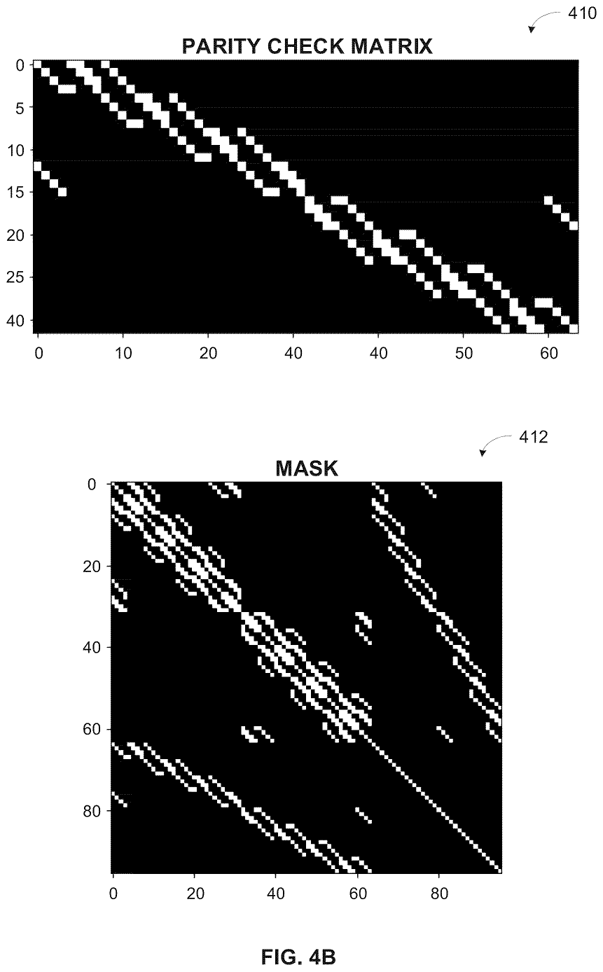

Reference is now made to FIG. 4A and FIG. 4B, which present schematic illustrations of exemplary masks computed for a transformer neural network based decoder based on a graphical representation of respective error correction codes, according to some embodiments of the present invention.

Illustrations 400 and 410 provide the parity-check matrices of a 2-Toric code, and a 4-Toric code respectively. Illustrations 402 and 412 present respective masks derived for the 2-Toric code and the 4-Toric code from their respective parity-check matrices. Each of the parity-check matrices comprises two block matrices, a first one for bit-flips X a second one for phase-flips Z stabilizers.

As seen, the Toric code is characterized by high sparsity induces by its code architecture which indicates high locality, i.e., bits which are close to each other may be highly related (connected) while bits further away from each other may be less related (unconnected). This locality is expressed in the masks which may only reflect stabilizers-related elements.

Reference is made once again to FIG. 3.

Since the decoding layers 304 is adapted to compute an estimated logical operator matrix of the received encoded codeword, the metric used for training and optimizing the decoding layers 304 may be the Logical Error Rate (LER), which may provide valuable information on the practical decoding performance. Given the code's logical operator in its matrix form is [symbol] ∈{0,1}^{n×k}, the LER loss function (objective) which is minimized during training may be expressed by equation 8 below.

$${ℒ}_{LER} = BCE ( 𝕃 ( s ) , {f}_{θ} ( s ) 𝕃ε ) \qquad Equation 8$$

Where the multiplications are performed over GF(2) and are thus highly non-differentiable.

Moreover, the loss function (objective) used to train and optimize the decoding layers 304 may employ a differentiable equivalence mapping of the XOR, i.e., sum over GF(2) operation. Defining the bipolar mapping φ:{0,1}→{±1} over GF(2) as φ(u)=1−2u, u∈{0,1}, may yield the property φ(u⊕v)=φ(u)φ(v), ∀u, v∈{0,1}. Therefore, [symbol] ᵢ being the i-th row of [symbol] and x a binary vector may yield ∀i∈{1 . . . k} as expressed in equation 9 below.

$$∧ {( 𝕃 , x )}_{i} := {𝕃}_{i} ⊕ x = {ϕ}^{- 1} ( {\prod }_{j} ϕ ( ( {𝕃}_{i} ) \cdot {x}_{j} ) ) \qquad Equation 9$$

As such, as the composition of differentiable functions ∧( [symbol] ,x) is differentiable, the objective function may be defined by equation 10 below.

$${ℒ}_{LER} = BCE ( ∧ ( 𝕃 , bin ( {f}_{θ} ( s ) ) ) , 𝕃ε ) \qquad Equation 10$$

Where bin denotes the binarization (binary quantization) of the soft prediction of the trained model.

As reflected in the above equations, the loss function of the LER used for training the decoding layers 304 may be defined based on the binary cross entropy loss across the predicted soft error computed by the trained transformer neural network based decoder 104A. Moreover, the LER loss function may be redefined as a differentiable loss function using the differentiable equivalence mapping of XOR operation over the binary module two GF(2) thus enabling minimization of the differentiable loss function of the LER. In particular, the differentiable LER loss function may be defined based on binarization of the predicted soft error of the logical operator matrix of the codeword encoded using the QECC code.

The binary quantization of the activations in the decoding layers 304 may be done based on its differentiable approximation with the sigmoid function bin(x)=σ(x)=(1+e^{-x})⁻¹ which may improve decoding performance compared to other binary quantization methods known in the art, for example, Straight-Through Estimator (STE), and/or the like.

In addition to directly minimizing the LER metric, it is desirable to identify noise prediction solutions which are close to the real system noise, for example, by regularizing the differentiable loss function (objective) of the LER with the classical Bit Error Rate (BER) loss function (objective) defined by [symbol] _{BER}=BCE(f_{θ}(s),ε).

An overall loss function (objective) for training the decoding layers 304 may be therefore directed to minimize the Logical Error Rate (LER), the bit error rate (BER), and the error rate of the noise estimator as expressed in equation 11 below.

$$ℒ = {λ}_{BER} {ℒ}_{BER} + {λ}_{LER} {ℒ}_{LER} + {λ}_{g} {ℒ}_{g} \qquad Equation 11$$

Wherein λ_{BER}, λ_{LER}, and λ_{g} denote weights of each of the loess functions [symbol] _{BER}, [symbol] _{LER}, and [symbol] _{g} respectively in the overall loss function.

In the presence of measurement errors, each syndrome measurement may be repeated T times thus increasing the input to the decoder 104A by an additional time dimension. Formally, given that binary system noises may be expressed by

$${\{ {ε}_{t} \}}_{t = 1}^{T}$$

and binary measurement noises may be expressed by

$${\{ {\tilde{ε}}_{t} \}}_{t = 1}^{T} ,$$

the syndrome sₜ at a given time t∈ [symbol] ₊ may be defined using equation 12 below.

$${s}_{t} = ( H ( x ⊕ {ε}_{1} ... ⊕ {ε}_{t} ) ) ⊕ {\tilde{ε}}_{t} \qquad Equation 12$$

In order to remain invariant to the number of measurements, each measurement may be first analyzed separately followed by a global decoding performed by applying a symmetric pooling function, for example, an average, in the middle of the neural decoder 104A. Given a NN decoder 104A with N decoding layers 304 and the hidden activation tensor φ∈ [symbol] ^{T×n×d}^{ₗ} at layer l=N/2, the new pooled embedding may be given by summation along the first dimension

$$\tilde{φ} = \frac{1}{T} {\sum }_{t} {g}_{ω} ( {s}_{t} ) {φ}_{t} .$$

The loss function [symbol] _{g} may be therefore defined as the distance between the pooled embedding and the noise as expressed in equation 13 below.

$${ℒ}_{g} = BCE ( {\sum }_{t} {g}_{ω} ( {s}_{t} ) / T , ε ) \qquad Equation 13$$

Wherein ε is the cumulative binary system noise.

Since the ECCT architecture is extended to its quantum counterpart (QECCT), the hidden activation tensor may now be in a shape φ∈ [symbol] ^{T×h×n×d}^{ₗ} where h is the number of self-attention heads, and pooling is performed at the [N/2] transformer block. An advantage of this approach is its low computational cost since the analysis and comparison are performed in parallel at the embedding level.

The initial encoding conducted at the input layer 302 may be defined as a d dimensional one-hot encoding of the n+nₛ input elements where n is the number of physical qubits and nₛ is the length of the syndrome s. The shallow network noise estimator g_{ω} may comprise, for example, two fully connected (FC) layers of hidden dimensions equal to 5n and with a GELU non-linearity.

The decoding may be conducted by a concatenation of the N decoding layers 304 each comprising self-attention and feed-forward layers interleaved with normalization layers between them. In case of faulty syndrome measurements, the [N/2]^{th} layer may perform average pooling over the time dimension.

The output layer 306 adapted to produce a vector representing a predicted soft error of the logical operator matrix of the received codeword may be configured to reduce a dimension of the soft error vector concatenating a plurality of soft error vectors computed by the plurality of decoding layers 304 based on the embeddings created by the input layer 302.

For example, the output layer 306 may comprise two fully connected (FC) layers, a first layer configured to reduce the element-wise embedding to a one dimensional n+nₛ vector and a second layer configured to further reduce the vector to an n dimensional vector representing the soft decoded noise trained over the loss function (objective) of equation 11, i.e., the soft error of the logical operator matrix of the codeword.

The logical operator L may be than applied to the estimated soft error of the logical operator matrix h(L,σ(z)) to recover the encoded codeword z which is output from the decoder 104A.

The complexity of the decoder 104A is linear with the code length n and quadratic with the embedding dimension d and may be defined by [symbol] (Nd²n) for sparse codes, for example, topological codes.

As described herein before, the decoder 104A, specifically the decoding layers 304, may be trained by minimizing and/or optimizing the loss function (objective) of equation 11.

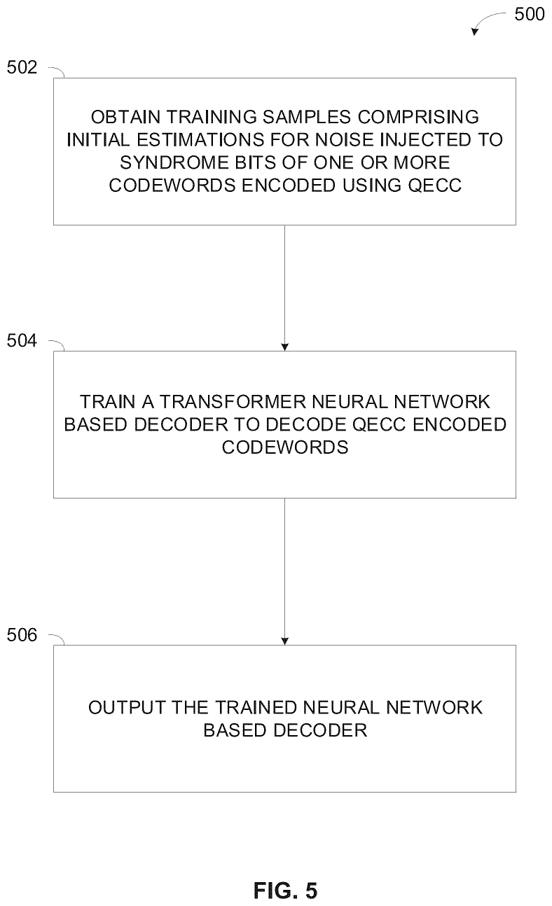

Reference is now made to FIG. 5, which is a flowchart of an exemplary process of training a transformer neural network based decoder to decode quantum error correction codes, according to some embodiments of the present invention.

An exemplary process 500 may be executed for training one or more transformer neural network based QECC decoders such as the decoder 104, for example, the decoder 104A.

The process 500 may be executed by one or more systems, platforms, and/or services, collectively designated training system herein after, comprising one or more hardware processors adapted to execute program instructions stored in a non-transitory storage (program store). Optionally, the hardware processor(s) executing the training process 500 may be supported by one or more hardware elements available and/or utilized by the training system, for example, an Artificial Intelligence (AI) accelerator, a Graphic Processing Unit (GPU), and/or the like.

Optionally, the training system may comprise one or more network interfaces for connecting to one or more wired and/or wireless networks, for example, a Local Area Network (LAN), a Wireless LAN (WLAN, e.g., Wi-Fi), a Wide Area Network (WAN), a Municipal Arca Network (MAN), a cellular network, the internet, and/or the like. Via the network(s), the training system may communicate with one or more remote resources, for example, a server, a cloud service, a database, a storage resource, and/or the like.

As shown at 502, the process 500 starts with the training system obtaining a plurality of training samples. The training system may obtain the training samples, for example, fetch, retrieve, receive, and/or the like from one or more sources, for example, a local storage device (e.g., hard drive, memory, etc.), a remote resource accessible via the network(s) (e.g. a database, a storage server, etc.)

The plurality of training samples may comprise a plurality of initial noise estimations computed by one or more noise estimators, for example, a neural network based noise estimator such as the noise estimator g_{ω} for noise injected to syndrome bits of one or more codewords encoded using one or more quantum error correction codes (QECC) and transmitted over one or more transmission channels such as the transmission channel 106 subject to interference.

Optionally, the training samples may comprise initial noise estimations computed for the zero codeword encoded using the QECC code(s) and transmitted over the transmission channel(s) 106 subject to interference

As shown at 504, the training system may use the plurality of training samples to train the transformer neural network based decoder 104A to decode codewords encoded using the QECC code(s).

In particular, as described herein before, the decoder 104A may be trained to decode QECC encoded codewords, by (1) computing an estimated logical operator matrix of the training codeword(s) by minimizing the combined loss function (objective) directed to minimize the LER, the BER, and the error rate of the noise estimator g_{ω}, and (2) producing a vector representing a predicted soft error of the logical operator matrix of the codeword.

As shown at 506, the training system may outputting the trained transformer neural network based decoder 104A for decoding one or more codewords, specifically not previously seen codewords, which are encoded using one or more QECC codes. For example, the trained decoder 104A may be used by one or more decoding systems adapted to decode codewords encoded using one or more QECC codes.

The training dataset may be defined, constructed, and/or selected according to one or more parameters, for example, an architecture of the decoder 104A, a desired decoding performance, capacity and/or computing resources (e.g., processing resources, storage resources, computing time, etc.) of the training system, and/or the like.

For example, for an exemplary decoder 104A in which N=6, i.e., 6 decoding layers 304, and d=128, an exemplary training session may be based on a training dataset comprising 512 training samples per minibatch, for 200 to 800 epochs depending on the QECC code length, with 5000 minibatches per epoch.

The training may be performed by randomly sampling noise in the physical error rate testing range. The default weight parameters selected for the loss functions (objectives) are λ_{BER}=0.5, λ_{LER}=1, and λ_{g}=0.5. It should be noted, that other configurations and/or longer training datasets can be beneficial and may improve decoding performance of the decoder 104A.

The learning rate of the decoder 104A may be initialized to a desired rate value, for example, 5·10⁻⁴ coupled with a cosine decay scheduler down to 5·10⁻⁷ at the end of training. No warmup as known in the art was employed.

The training time may range from 153 to 692 seconds per epoch for the 32 to 400 code lengths, respectively for a decoder 104A with the default N=6, and d=128 architecture.

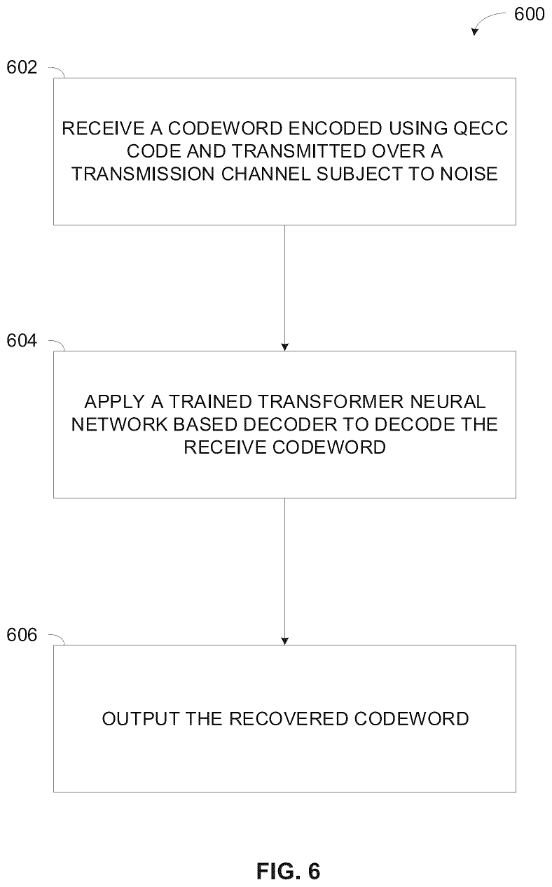

Reference is now made to FIG. 6, which is a flowchart of an exemplary process of using a trained transformer neural network based decoder to decode quantum error correction codes, according to some embodiments of the present invention.

An exemplary process 600 may be executed for decoding one or more codewords encoded using one or more QECC codes using a transformer neural network based QECC decoder such as the decoder 104, for example, the decoder 104A.

The process 600 may be executed by one or more systems, platforms, and/or services, collectively designated decoding system herein after, comprising one or more hardware processors adapted to execute program instructions stored in a non-transitory storage (program store). Optionally, the hardware processor(s) executing the decoding process 600 may be supported by one or more hardware elements available and/or utilized by the decoding system, for example, an AI accelerator, a GPU, and/or the like.

As shown at 602, the process 600 may start with the decoding system receiving initial noise estimations computed by one or more noise estimators such as the noise estimator go for noise injected to syndrome bits of one or more received codewords encoded using a quantum error correction code and transmitted over a transmission channel such as the transmission channel 106 subject to interference.

As shown at 604, the decoding system apply a trained neural network based decoder such as the decoder 104, for example, the decoder 104A which is adapted and trained to compute an estimated logical operator matrix of the received codeword(s) and produce a vector representing a predicted soft error of the logical operator matrix.

As shown at 606, the decoding system may output the vector representing the predicted soft error.

While the decoder 104 may be universal in terms of the QECC codes it is adapted to decode, the decoder 104, for example, the decoder 104A are highly applicable and efficient for decoding topographic codes, for example, surface codes and, Toric codes, which are variant of the surface codes with periodic boundary conditions. Such surface codes are highly appealing candidates for quantum computing experimental realization as they may be implemented on a two-dimensional grid of qubits with local check operators. In these codes, the physical qubits are placed on the edges of a two-dimensional lattice of length L, such that the stabilizers are defined with respect to the code lattice architecture that defines the codespace, where k=2, n=2L².

The stabilizers may be defined in two groups. Vertex operators may be defined on each vertex as the product of X operators on the adjacent qubits and plaquette operators may be defined on each face as the product of Z operators on the bordering qubits. Therefore, there exist a total of 2L² stabilizers, L² for each stabilizer group.

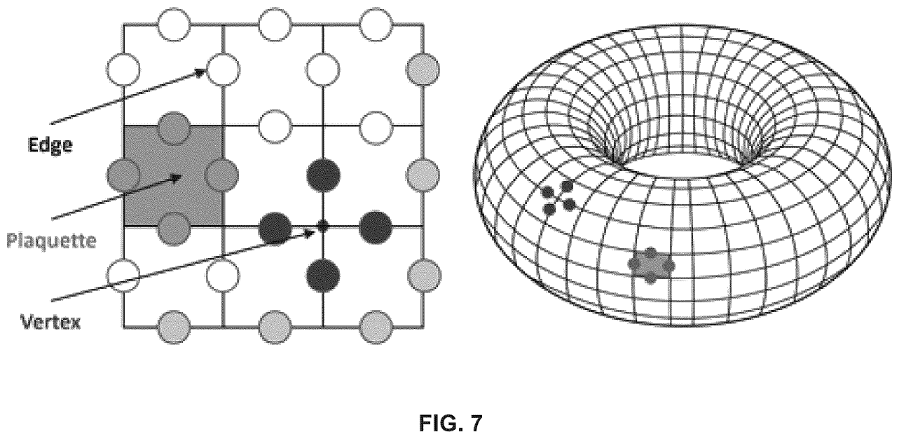

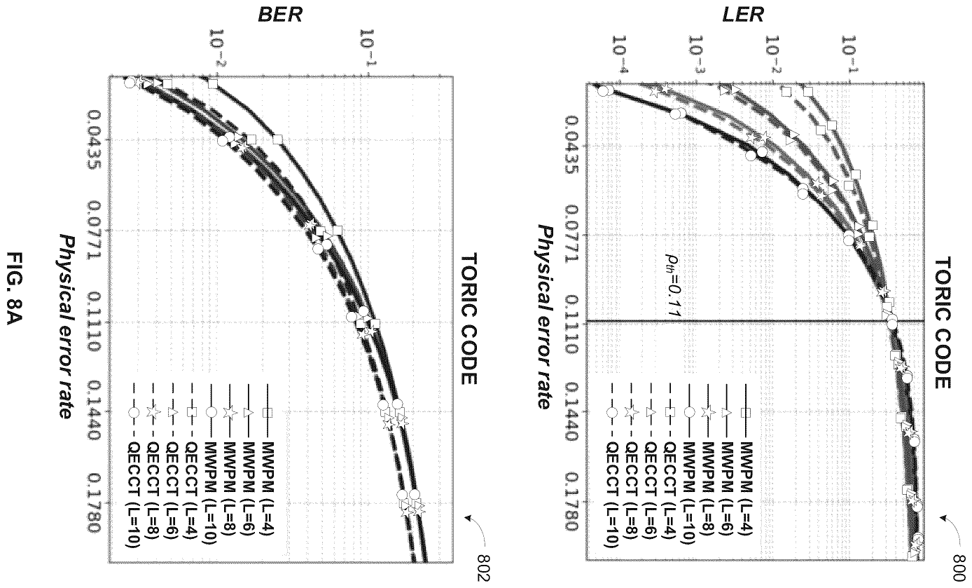

Assuming that a qubit is associated with every edge of the lattice, for a given vertex v the vertex operator may be defined as xᵥ=Π_{i∈v}Xᵢ, and for a given plaquette p the plaquette operator may be defined as Zₚ=Π_{i∈v}Zᵢ as illustrated in FIG. 7, which is a schematic illustration of an lattice representation of an exemplary Toric code used by a transformer neural network based decoder such as the decoder 104, for example, the decoder 104A, according to some embodiments of the present invention.

Presented herein are experiments conducted to evaluate and demonstrate the performance of the transformer neural network based QECC decoder 104, specifically the transformer neural network based QECC decoder 104A (QECCT).

In the experiments, Toric code of various lengths were evaluated while considering two common noise models, independent noise and depolarization noise. In independent (uncorrelated) noise, X (bit-flip) and Z (phase-flip) errors may occur independently and with equal probabilities. Therefore, decoding may be performed on the X or Z stabilizers separately.

For depolarization noise, equal probability p/3 may be assigned to all three Pauli operators [symbol] (X)= [symbol] (Z)= [symbol] (Y)=p/3, [symbol] (I)=1−p, where Y is the Pauli operator defined as Y=iXZ.

In the experiments where measurement errors are incorporated, each syndrome measurement is repeated T=n times and the probability of the measurement error is the same as the probability of the syndrome error, i.e., the distributions of ε and \tilde{ε} in equation 12 are the same.

As a baseline for performance comparison, the Minimum-Weight Perfect Matching (MWPM) decoding algorithm is considered with the complexity of [symbol] ((n³+n²) log (n)), also known as the Edmond or Blossom algorithm, which is the most popular decoder for topological codes. The MWPM decoder is implemented as known in the art, and is close to quadratic average complexity. In the experiments, the code lengths of the evaluated codes are similar to those used for testing existing end-to-end neural network based decoders, namely code lengths of 2<L≤ 10.

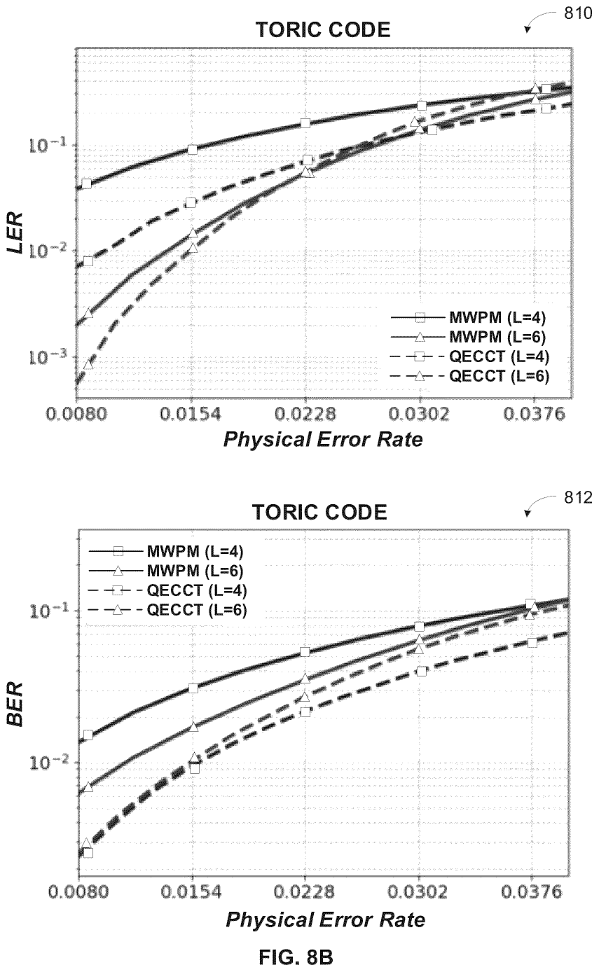

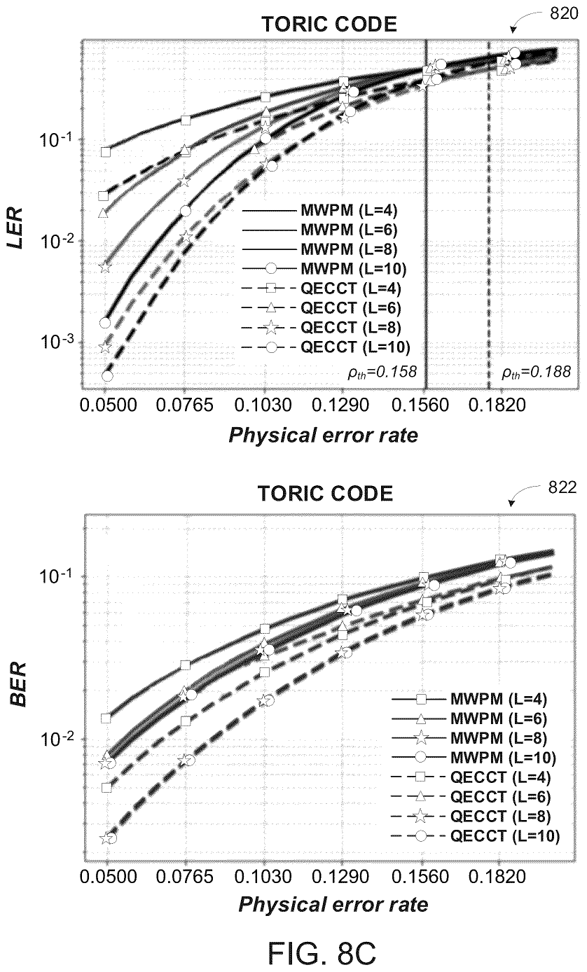

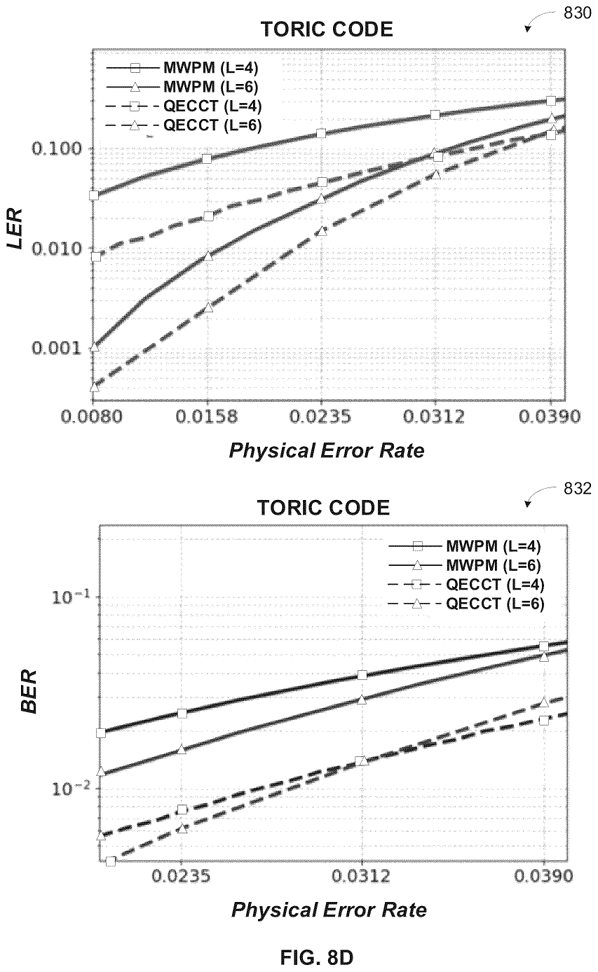

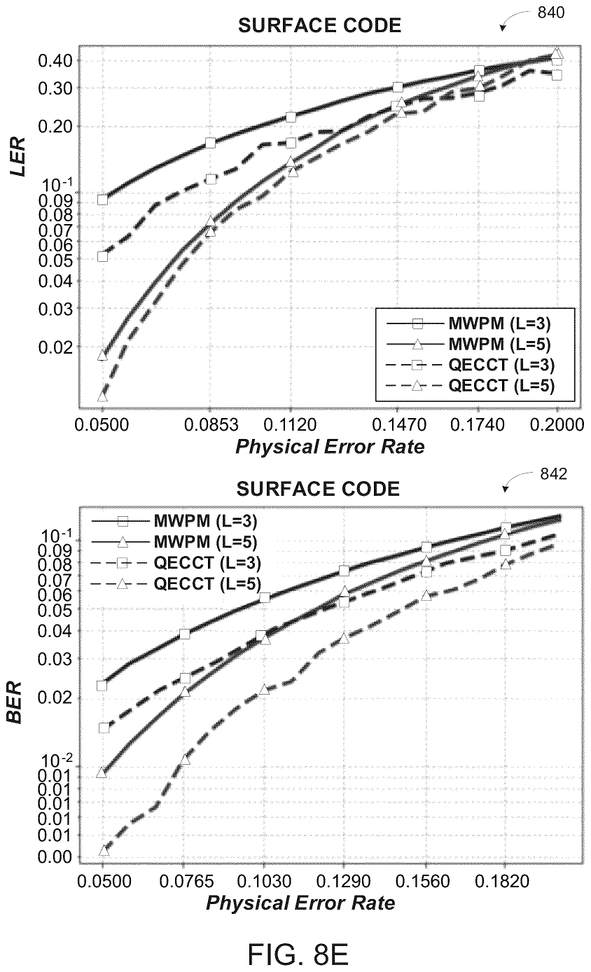

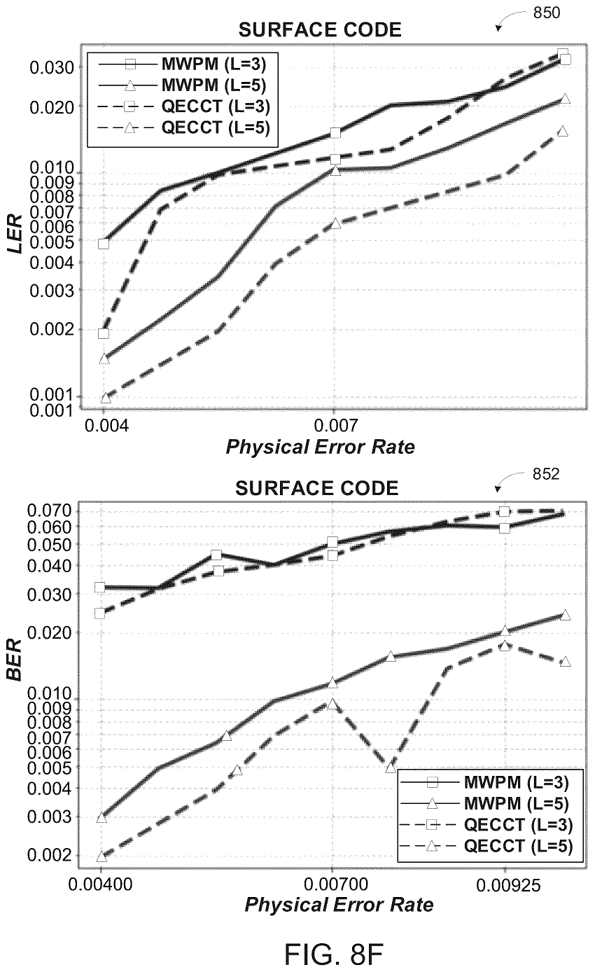

Reference is now made to FIG. 8A, FIG. 8B, FIG. 8C, FIG. 8D, FIG. 8E and FIG. 8F, which are graph charts comparing decoding performance for several legacy decoders and transformer neural network based decoders applied to decode quantum error correction codes, according to some embodiments of the present invention.

As metrics for evaluating performance of the transformer neural network based QECC decoder 104, specifically decoder 104A, designated QECCT herein after, and MWPM algorithm, both the Bit Error Rate (BER) and the Logical Error Rate (LER) described herein before are used. The LER metric used herein is a word-level error metric, meaning there is an error if at least one qubit is different from the ground truth.

Graph charts 800 and 802 depicts the performance of the QECCT compared to the MWPM algorithm for different Toric code lengths under the independent noise model and without noisy measurements. Graph charts 820 and 822 present a similar comparison with between the QECCT and the MWPM for noisy measurements with T=L and uniformly distributed syndrome error.

Graph charts 830 and 832 show a comparison between the QECCT decoder and the MWPM for the depolarized noise model, with and without noisy measurements, respectively. The graph charts also show the obtained threshold values.

As can be seen in the graph charts, the QECCT outperforms the state of the art MWPM algorithm by a large margin. First the QECCT outperforms the MWPM algorithm on independent noise, where, as known in the art, MWPM almost reaches the state of the art ML algorithm's threshold. The QECCT also outperforms the MWPM on the challenging depolarization noise setting by a large margin, where the obtained threshold of the QECCT is 0.178 compared to 0.157 for MWPM and 0.189 for ML.

The very large gaps in BER performance may imply that the QECCT is able to better detect exact corruptions. The threshold is slightly lower for L=10 with depolarization noise while the BER is much lower, denoting a potential need for tuning the regularization parameter for larger codes.

The experiments conducted for the QECCT extend beyond what is commonly done for the relevant ML algorithms. In order to determine that the QECCT is applicable for QECC codes other than just Toric codes.

Graph charts 840 and 842 show the performance for different Surface code lengths of the QECCT decoder 104A compared to the MWPM algorithm under the depolarization noise model. The same parameters as were used for Toric codes are used for the Surface codes. As can be seen, the QECCT outperforms the MWPM algorithm for other codes as well, namely Surface codes as it outperforms the MWPM for Toric codes. The large gap in BER performance in favor of the QECCT may probably mean that the gap in LER may be even larger with other hyperparameters defined for the loss function (objective).

To demonstrate generality with respect to noise models, graph charts 850 and 852 show the performance of the QECCT and MWPM under the circuit noise model for different Surface code lengths. The transmission channel is simulated using the state of the art STIM simulator of quantum stabilizer circuits where the same depolarization error probability is applied after every single and two-qubit Clifford operation, before every stabilizer measurement, and before the syndrome measurement. Evidently, the QECCT consistently outperforms the MWPM for this type of channel noise as well.

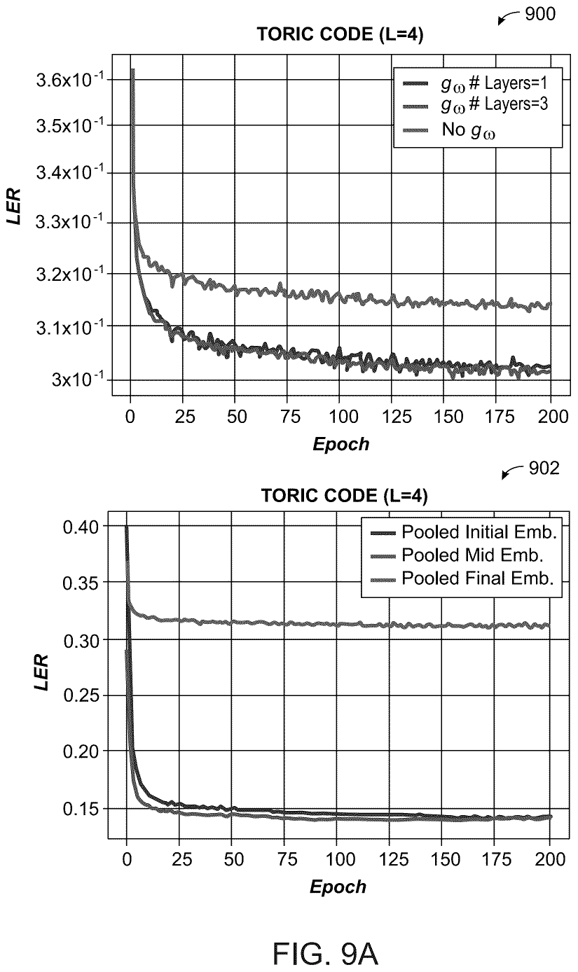

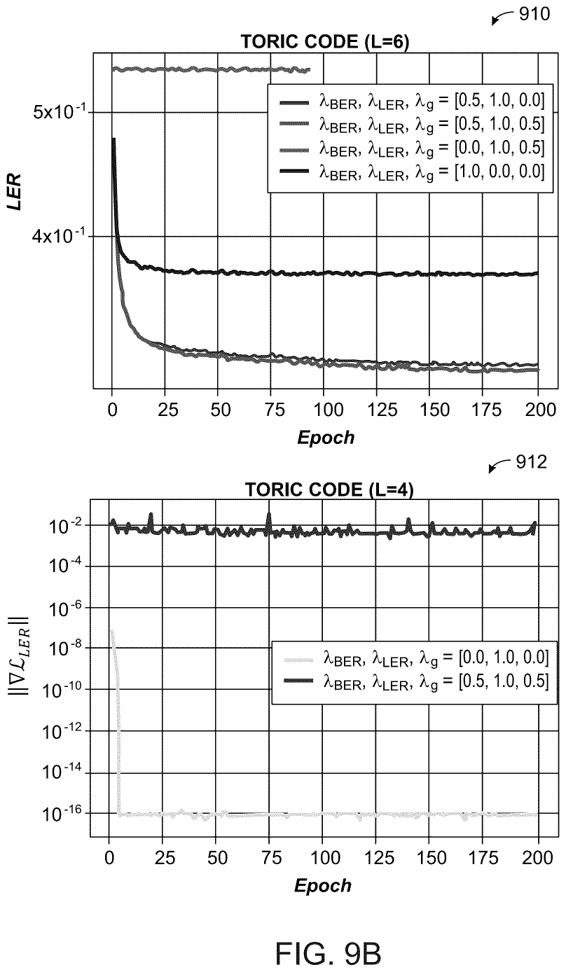

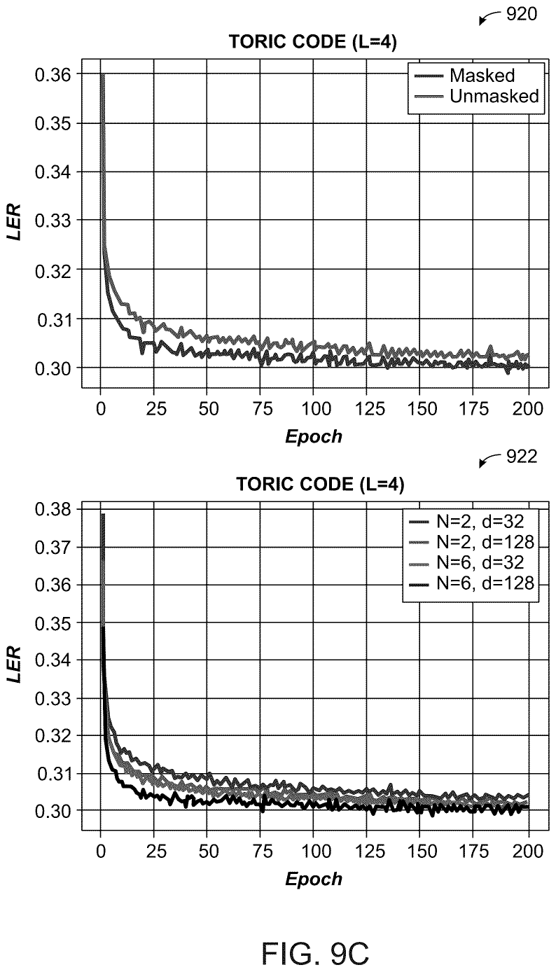

Reference is now made to FIG. 9A, FIG. 9B and FIG. 9C, which are graph charts demonstrating impact of design parameters on decoding performance of transformer neural network based decoders applied to decode quantum error correction codes, according to some embodiments of the present invention.

Graph charts 900 and 902 present the impact of the noise estimator g_{ω} on the performance of the QECCT decoder 104A implemented with an N=6, d=128 neural network architecture.

In particular, the graph charts 900 and 902 show comparison of the performance of the QECCT when using initial scaling (noise) estimate computed by the noise estimator g_{ω} and constant mapping with ones, using no g_{ω}, meaning g_{ω}:=1ₙ. Moreover, the impact on performance is demonstrated for two neural network architectures implementing the noise estimator g_{ω}, one with a single hidden layer (Layers=1) and one with three hidden layers (layers=3).

As seen, the average testing LER of mid-level pooling is 5% lower than the initial embedding pooling. Evidently, the initial noise estimator g_{ω} is critical for performance. However, the network architecture is less impactful. Given more resources, additional architectures may be explored.

The Graph chart 902 may also demonstrate the impact of different pooling (averaging) scenarios. Pooling may be performed either after the initial embedding at the input layer 302 (designated Pooled Initial Emb. In the graph), in the middle of the neural network in the decoding layers 304 (designated Pooled Mid Emb. In the graph), or over the final embedding in the output layer 306 (designated Pooled Final Emb. In the graph). Evidently, performing pooling in the middle layer may significantly increase decoding performance while pooling the final embedding (similarly to voting) is not effective.

Graph charts 910 and 912 demonstrate the impact of the various loss functions (objectives) used in equation 11. In particular, graph chart 910 shows the impact of each of the loss functions [symbol] _{BER}, [symbol] _{LER}, and [symbol] _{g} by assigning them respective weights λ_{BER}, λ_{LER}, and λ_{g} in the overall loss function, while graph chart 920 depicts the impact of regularization on the training dynamics for a QECCT decoder 104A employing N=6, d=128 neural network architecture.

First, it may be observed that training the decoder 104A solely with the [symbol] _{LER} loss function (objective) may converge rapidly to a bad local minimum. This is illustrated in graph chart 912 where the gradient norm average is displayed over the network layers. Training with [symbol] _{BER} only produces far worse results than combining it with the [symbol] _{LER} loss function. For high SNR, a QECCT decoder trained with [symbol] _{BER} may yield a 27 times higher LER compared to the same QECCT decoder trained with the combined loss function. Moreover, optimizing with the noise estimator loss function (objective) [symbol] _{g} results, for high SNR, in a 46% improvement over not employing regularization.

Graph chart 920 shows the impact of masking, i.e., using the mask derived from the QECC code on the performance of the QECCT decoder 104A implemented with an N=6, d=128 neural network architecture, specifically the impact of masking capacity of the QECCT decoder 104A and the Straight Through Estimator (STE) as bin function from equation 10 is evaluated and demonstrated. As can be seen, while less important than with classical codes as known in the art, the mask still substantially impacts performance.

Graph chart 922 demonstrates the impact of the model size, i.e., the architecture of the transformer neural network implementing the QECCT decoder 104A on its decoding performance. As can be seen, increasing the capacity of the transformer neural network decoder 104A, i.e., increasing its decoding layers count, may yield better representation which may improve its decoding performance.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms error correction codes, quantum error correction codes, and error correction code decoding model are intended to include all such new technologies a priori.

As used herein the term “about” refers to □10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A transformer neural network based decoder for decoding quantum error correction codes, comprising:
an input layer adapted to:
receive initial noise estimation computed by a noise estimator for noise injected to syndrome bits of at least one codeword encoded using a quantum error correction code and transmitted over a transmission channel subject to interference, and
create embeddings for the syndrome bits;
a plurality of decoding layers adapted to compute an estimated logical operator matrix of the at least one codeword, each of the plurality of decoding layers comprises a self-attention layer comprising at least one head constructed according to a mask indicative of a relation between the embeddings, the relation between the embeddings is derived from a parity-check matrix of the error correction code such that the mask is adapted to unmask pairs of connected parity bits and mask pairs of unconnected parity bits; and
an output layer adapted to produce a vector representing a predicted soft error of the logical operator matrix of the at least one codeword;
wherein the plurality of decoding layers are trained using a combined loss function directed to minimize a logical error rate (LER), a bit error rate (BER), and an error rate of the noise estimator.

2. The neural network based decoder of claim 1, wherein the mask is created based on an extended bipartite graph representation of the parity check matrix of the error correction code, the bipartite graph representation comprises a plurality of nodes connected via a plurality of edges, each pair of connected bits comprises bits which share at least one node of the plurality of nodes and each pair of unconnected bits comprises bits which do not share any node of the plurality of nodes.

3. The neural network based decoder of claim 2, wherein the bipartite graph is a Tanner graph.

4. The neural network based decoder of claim 1, wherein each of the plurality of decoding layers further comprises a feed forward layer interleaved by a normalization layer from the self-attention layer.

5. The neural network based decoder of claim 1, wherein the embeddings created by the input layer have a higher dimension than the dimension of the received initial noise estimation.

6. The neural network based decoder of claim 1, wherein the output layer is configured to reduce a dimension of the soft error vector concatenating a plurality of soft error vectors computed by the plurality of decoding layers based on the embeddings.

7. The neural network based decoder of claim 1, wherein each of the combined loss function is adjusted according to a respective weight assigned to each of the LER, the BER, and the error rate of the noise estimator.

8. The neural network based decoder of claim 1, wherein the parity-check matrix comprises a bit-flip parity check matrix computed for correcting qubits bit-flips and a phase-flip parity check matrix computed for correcting qubits phase-flips.

9. The neural network based decoder of claim 1, wherein the noise estimator is implemented using at least one shallow neural network parametrized during training using a plurality of training samples comprising a plurality of sets of syndrome bits injected with a noise.

10. The neural network based decoder of claim 1, wherein the quantum error correction code is a member of a group comprising: a stabilizer code, a surface code, and a topological code.

11. A method of training a transformer neural network based decoder for decoding quantum error correction codes, comprising:
using at least one processor for:
obtaining a plurality of training samples comprising a plurality of initial noise estimations computed by at least one noise estimator for noise injected to syndrome bits of at least one codeword encoded using at least one quantum error correction code and transmitted over at least one transmission channel subject to interference;
using the plurality of training samples to train a transformer neural network based decoder to decode codewords encoded using the at least one quantum error correction code by:
computing an estimated logical operator matrix of the at least one codeword by minimizing a combined loss function directed to minimize a logical error rate (LER), a bit error rate (BER), and an error rate of the noise estimator, and
producing a vector representing a predicted soft error of the logical operator matrix of the codeword; and
outputting the trained transformer neural network based decoder for decoding at least one codeword encoded using at least one quantum error correction code.

12. The method of claim 11, wherein a loss function of the LER is defined based on a binary cross entropy loss across the predicted soft error computed by the trained transformer neural network based decoder.

13. The method of claim 12, further comprising redefining the loss function of the LER as a differentiable loss function using a differentiable equivalence mapping of XOR operation over a binary module two thus enabling minimization of the differentiable loss function of the LER.

14. The method of claim 13, further comprising defining the differentiable loss function of the LER based on binarization of the predicted soft error.

15. The method of claim 12, further comprising regularizing the differentiable loss function of the LER.

16. The method of claim 11, wherein the at least one noise estimator comprises at least one shallow neural network trained to compute the initial noise estimations using a plurality of training samples comprising syndrome bits of the at least one codeword encoded using the at least one quantum error correction code by minimizing a binary cross entropy loss across the syndrome bits.

17. The method of claim 11, wherein the at least one encoded codeword used for creating the training samples comprise the zero codeword.

18. (canceled)
